(19) United States
(12) Patent Application Publication
(10) Pub. No.: US 2011/0244252 A1
(43) Pub. Date: Oct. 6, 2011

(54) SOLDER ALLOY

(75) Inventor: Peng Chum Loh, Singapore (SG)

(73) Assignee: AUTIUM PTE LTD, Singapore (SG)

(21) Appl. No.: 13/124,214

(22) PCT Filed: Sep. 30, 2009
(86) PCT No.: PCT/SG2009/000360

§ 371 Date: Apr. 14, 2011

(30) Foreign Application Priority Data
Oct. 15, 2008 (SG) 200807695-2

(51) Int. Cl. B32B 15/04; B23K 35/22; B23K 1/20; B32B 15/00; B32B 18/00

(52) U.S. Cl. 428/433; 148/22; 228/256; 428/457; 428/450

(57) ABSTRACT

A solder alloy having a composition comprising at least two eutectic alloy compositions is provided. A method of joining two workpieces with the use of the solder alloy is also provided.

### FIELD OF INVENTION

The invention relates to solder alloy, and in particular, to solder alloy having a composition comprising at least two eutectic alloy compositions. The solder alloy is suitable for forming a solder joint between metal, ceramic, glass or glass-ceramic. The invention further relates to a method of joining two workpieces with the use of the solder alloy.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Soldering is a well-established technique commonly used for joining apparatus or workpieces together via a solder joint. Often, the surfaces of the workpieces are cleaned prior to applying a solder alloy at the solder joint. This is to ensure that the surfaces are free of any oxide layers and a good contact of the solder alloy with the workpieces.

Further, in early solder alloy composition consisting of tin-lead, flux additives are necessary to prevent the oxidation at the solder joints, where the oxidation causes deterioration of the solder joints.

In addition, such tin-lead solder alloy, although possessing a low soldering temperature at about 200° C., does not sufficiently wet the surfaces of the workpieces having poor wettability properties. Such workpieces include ceramic, glass, and glass-ceramic materials. Few attempts to improve the wettability properties of such workpieces include the incorporation of titanium in the solder alloy. Such solder alloy improves the wetting on poor wettability surfaces such as ceramics. Nevertheless, a high soldering temperature above 600° C. is needed due to the high melting point of titanium. Moreover, the soldering needs to be carried out in a high vacuum or with a shielding gas.

It is therefore desirable to provide a solder alloy that overcomes, or at least alleviates, the above problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In a first aspect of the present invention, there is provided a solder alloy having a composition comprising at least two eutectic alloy compositions.

In a second aspect of the present invention, there is provided a method for joining at least two workpieces through a solder joint. The method comprises providing at the solder joint a solder alloy in accordance with the first aspect of the present invention between the at least two workpieces to be joined, heating the solder alloy at a soldering temperature below 230° C. in a soldering environment, and cooling the heated solder alloy to thereby form the solder joint.

In a third aspect of the present invention, there is provided a solder joint between at least two workpieces to be joined, the solder joint comprising the solder alloy in accordance with the first aspect of the present invention.

### DETAILED DESCRIPTION

The invention relates to a solder alloy having a composition comprising at least two eutectic alloy compositions. The solder alloy is suitable for forming a solder joint between metal, ceramic, glass or glass-ceramic.

In accordance with a first aspect of the invention, there is provided a solder alloy having a composition comprising at least two eutectic alloy compositions, wherein the eutectic alloy compositions may be binary, ternary or quaternary.

The eutectic alloy compositions are selected such that the resultant solder alloy has a melting temperature below 230° C., and more preferably, below 200° C. Each eutectic alloy composition may be selected from the group consisting of Sn—Zn, Sn—Bi, Sn—Cu, Sn—Ag, Al—Si, Sn—Ag—Cu, Sn—Ag—Cu—Bi, and Sn—Ag—In—Bi. Other eutectic compositions apparent to a person skilled in the art are also possible.

In addition to the eutectic compositions, elemental metals may also be present in the solder alloy. Such elemental metals are added to improve surface gloss, preservation stability, or to reduce surface tension of the solder alloy at the solder joint. The elemental metals include, but not limited to, Ag, Cu, Fe, In, Mg, Mn, and mixture thereof.

In a second aspect of the present invention, there is provided a method for joining at least two workpieces through a solder joint. The method comprises providing at the solder joint a solder alloy in accordance with the first aspect of the present invention between the at least two workpieces to be joined. The workpieces may be metal, ceramic, glass, or glass-ceramic.

The solder alloy is then heated at a soldering temperature below 230° C. in a soldering environment. The metals in the eutectic compositions are reactive and are therefore able to prevent oxidation from occurring at the solder joint. This way, no flux additive is needed in the solder alloy. Further, the soldering may be carried out in atmosphere environment such as oxygen-containing atmosphere. Further still, no shielding gas is needed since the soldering may be carried out in non-high vacuum and low temperature environment.

At the soldering temperature, the solder alloy begins to melt and fuse within regions of the solder joint between the two workpieces. An intermetallic phase formed of the metals in the solder alloy and the workpieces occurs at the interface of the solder joint. Following this wetting phenomenon, the wettability property of the workpieces is improved. The fused solder alloy is finally cooled to thereby form the solder joint. Upon cooling, the fused solder alloy solidifies and firmly joins together the two workpieces. Preferably, the cooling of the fused solder alloy proceeds relatively slowly, especially when the workpieces have significantly different coefficients of thermal expansion; otherwise in the event of rapid and/or uneven cooling, cracking at the solder joint or in the workpieces themselves may form.

### EXAMPLES

### Example 1

Commercially available Sn—Zn eutectic composition and Al—Si eutectic composition are employed as the binary eutectic compositions forming the solder alloy of the present invention.

99.5 wt % of the Sn—Zn eutectic composition is mixed with 0.5 wt % of the Al—Si composition in an induction furnace. The mixture is melted in vacuum to prevent contamination of oxygen and nitrogen. The melt is then cooled to form a paste of the solder alloy.

To form a solder joint between an aluminium sheet and a glass, the aluminium sheet is first placed on an electric hotplate. The [Sn—Zn]-[Al—Si] solder alloy paste is then disposed on the aluminium sheet. The glass is subsequently placed on top of the solder alloy paste. A mechanical compression force provided by a spring-loaded steel rod between the aluminium sheet and the glass acts in the direction towards the hotplate, thereby clamping the aluminium sheet and glass together. The electric hotplate is then operated to provide heating in a direction from the aluminium sheet to the glass. The heating provides a soldering temperature of 200° C. At the same time, another heat source, e.g. resistance heating, is provided at the glass side and heating is provided in a direction from the glass to the aluminium sheet. This simultaneous heating on the top and on the bottom reduces thermal gradient between the aluminium sheet and the glass. Such low thermal gradient is essential to prevent cracking of the solder joint or the glass. After heating at 200° C. for a few minutes, the heating sources are stopped and the fused solder alloy is allowed to cool slowly to further prevent cracking.

### Example 2

The two eutectic compositions in the solder alloy composition are the same as in Example 1, except now 99.0 wt % of the Sn—Zn eutectic composition and 1.0 wt % of the Al—Si eutectic composition are mixed in an induction furnace to form a solder alloy and extrude into a fine soldering wire.

To form a solder joint between a stainless steel sheet and a ceramic, a butane flame and a heated rod used in conventional soldering technique are employed. The stainless steel sheet and the ceramic are similarly arranged and treated in the hotplate assembly described in Example 1. The soldering wire is positioned between the stainless steel sheet and the ceramic. The butane flame and the heated rod work to heat up the soldering wire, the stainless steel sheet, and the ceramic at a temperature of 200° C. to melt the soldering wire. The soldering wire fuses with the stainless steel sheet and the ceramic, thereby forming the solder joint.

### Example 3

90.0 wt % of Sn-Zn eutectic composition is mixed with 6.5 wt % of Sn—Ag—Cu eutectic composition in an induction furnace. Small amounts of In (3.4 wt %), Fe (0.03 wt %), Mg (0.05 wt %) and Mn (0.02 wt %) are added into the mixture. The mixture is melted in an inert shielding induction furnace to form a paste of the solder alloy. The small amount of Fe and Mn added would help nucleation and rapid uniform solidification.

To form a solder joint between a titanium sheet and a ceramic, a butane flame and a heated rod used in conventional soldering technique are employed. The titanium sheet and the ceramic are held together by applying load on top of the ceramic in place of a mechanical compression force provided by a spring-loaded steel rod as described in Example 1. Instead of arranging the titanium sheet and the ceramic in a hotplate assembly, the titanium sheet and the ceramic are arranged in a furnace where even heating by a flame, resistant heating is being carried out to melt the solder alloy, thereby forming the solder joint.

The afore-described solder alloy provides several advantages. No flux additive is needed. This eliminates the problem of removing the flux residues remaining in the soldered workpieces. Soldering is carried out in atmosphere environment without the need for a shielding gas or high vacuum. This dispenses with the need for expensive and sophisticated equipment. A low processing temperature below 230° C. reduces oxidation during soldering and significantly lower joint cracking that may come from thermal strains due to the differing coefficients of thermal expansion between the workpieces. This also helps to reduce the overall costs by reducing the dependency on more expensive heating elements. The addition of the second eutectic composition, e.g. Al—Si, helps to improve the ductility of the solder alloy which may easily be formed into a paste, foil, or wire and further aids in decomposition of surface oxides. The resultant solder joint possesses good joint strength and offers the possibility of joining two workpieces, whether similar or dissimilar materials, such as metal, glass, ceramic and glass-ceramic.

These solder alloys are suitable for watch parts, industrial glass components, machine tools e.g. ceramic cutters, engineering components, dental components, and metallization of electrical junctions in microelectronics.

Although the foregoing invention has been described in some detail by way of illustration and example, and with regard to one or more embodiments, for the purposes of clarity of understanding, it is readily apparent to those of ordinary skill in the art in light of the teachings of this invention that certain changes, variations and modifications may be made thereto without departing from the spirit or scope of the invention as described in the appended claims.

1-24. (canceled)

25. A solder alloy having a composition comprising at least two eutectic alloy compositions, wherein the at least two eutectic alloy compositions are selected from the group consisting of Sn—Zn, Sn—Bi, Sn—Cu, Sn—Ag, Al—Si, Sn—Ag—Cu, Sn—Ag—Cu—Bi, and Sn—Ag—In—Bi.

26. The solder alloy as recited in claim 25, wherein the at least two eutectic alloy compositions are Sn—Zn and Al—Si.

27. The solder alloy as recited in claim 26, wherein the solder alloy composition comprises 96-99.5 wt % of the Sn—Zn eutectic alloy composition and 0.5-4 wt % of the Al—Si eutectic alloy composition.

28. The solder alloy as recited in claim 27, wherein the solder alloy composition comprises 99.5 wt % of the Sn—Zn eutectic alloy composition and 0.5 wt % of the Al—Si eutectic alloy composition.

29. The solder alloy as recited in claim 27, wherein the solder alloy composition comprises 99.0 wt % of the Sn—Zn eutectic alloy composition and 1.0 wt % of the Al—Si eutectic alloy composition.

30. The solder alloy as recited in claim 25, wherein the at least two eutectic alloy compositions are Sn—Zn and Sn—Ag—Cu.

31. The solder alloy as recited in claim 30, wherein the solder alloy composition comprises 90-99.5 wt % of the Sn—Zn eutectic alloy composition and 0.5-10 wt % of the Sn—Ag—Cu eutectic alloy composition.

32. The solder alloy as recited in claim 25, wherein the melting point of the solder alloy is below 230° C.

33. The solder alloy as recited claim 32, wherein the melting point of the solder alloy is below 200° C.

34. The solder alloy as recited in claim 25, further comprising an elemental metal.

35. The solder alloy as recited in claim 34, wherein the elemental metal is selected from the group consisting of Ag, Cu, Fe, In, Mg, Mn, and mixture thereof.

36. The solder alloy as recited in claim 35, wherein the solder alloy composition comprises 0-4 wt % of the elemental metal.

37. A method for joining at least two workpieces through a solder joint, the method comprising:
providing at the solder joint a solder alloy as recited between the at least two workpieces to be joined;
heating the solder alloy at a soldering temperature below 230° C. in a soldering environment; and
cooling the heated solder alloy to thereby form the solder joint.

38. The method as recited in claim 37, wherein the soldering temperature is below 200° C.

39. The method as recited in claim 37, wherein the soldering environment is atmospheric.

40. The method as recited in claim 37, wherein the soldering environment does not contain a shielding gas.

41. The method as recited in claim 37, wherein the heating does not include the use of flux.

42. The method as recited in claim 37, wherein at the solder joint, each of the at least two workpieces consists of a metal, ceramic, glass or glass-ceramic.

43. A solder joint between at least two workpieces to be joined, the solder joint comprising the solder alloy as recited in claim 25.

44. The solder joint according to claim 43, wherein one of the at least two workpieces is a ceramic.

45. The solder joint according to claim 43, wherein one of the at least two workpieces is a glass-ceramic.

46. The use of the solder alloy as recited in claim 25 as a solder joint.
